(19) United States
(12) Patent Application Publication
(10) Pub. No.: US 2015/0338873 A1
(43) Pub. Date: Nov. 26, 2015

(54) VEHICLE FOOT PEDAL STROKE LIMITING TOOL

(71) Applicant: Toyota Motor Engineering & Manufacturing North America, Inc., Erlanger, KY (US)

(72) Inventor: William T. Pepe, Surprise, AZ (US)

(73) Assignee: Toyota Motor Engineering & Manufacturing North America, Inc., Erlanger, KY (US)

(21) Appl. No.: 14/285,214

(22) Filed: May 22, 2014

(51) Int. Cl. G05G 5/04; G05G 1/44; G05G 25/00

(52) U.S. Cl. CPC G05G 5/04; G05G 25/00; G05G 1/44

(57) ABSTRACT

A vehicle pedal stroke limiting tool is configured for testing applications within a host vehicle which includes a conventional brake, clutch and/or throttle pedal assembly disposed between the operator's seating position and a vehicle cabin bulkhead, wherein the pedal assembly is manually displaced by operator foot action between a released position and an extended position. The pedal stroke limiting tool includes a base member which is temporarily mounted on the foot pad of the pedal assembly for travel therewith. A stop arm is affixed to the base member and is selectively adjustable to extend toward the cabin bulkhead for stopping travel of the pedal assembly before it reaches its extended position. Force and displacement sensors are mounted to the stroke limiting for obtaining test data.

### TECHNICAL FIELD

The present disclosure relates to a structure for controlling the displacement of a vehicle pedal. More particularly, the present disclosure relates to apparatus for controlling displacement of a vehicle service brake pedal during the performance of certain test procedures.

### BACKGROUND

Brake pedal assemblies for applying brakes of an automotive vehicle typically comprise an elongated brake lever pivotally mounted on a bracket at a point adjacent the upper end of the brake lever permitting swinging movement of the cantilevered lower end of the lever forwardly to a brake applying position and rearwardly to a brake release position. The brake lever has a head on the upper end and a pedal on the lower end.

Devices intended to limit displacement of a vehicle brake lever under certain circumstances are known. For example, a brake pedal assembly comprising a brake lever pivoted on a mounting bracket for normal pivotal movement in opposite directions between a brake applying position and a brake release position. A brake lever displacement limiter is provided comprising an abutment feature positioned to be struck by the brake lever to block it from moving beyond the brake release position. This device is incorporated within original equipment provided with the vehicle for full time usage during operation and is intended to mitigate injury to the vehicle driver by preventing excess travel of the brake pedal beyond the release position upon impact in the case of an accident.

Conventionally, testing of the operation of vehicle control pedals, and their related systems (e.g., brake, clutch, throttle, and the like), was accomplished by manual actuation by a service technician. If required, certain test apparatus and transducers were temporarily mounted on the vehicle during the testing procedures and removed thereafter.

Another example describes a tool which compares the total distance from a vehicle floorboard of an unactuated brake pedal to the pedal reserve distance upon actuation. The caliper compares a pair of relatively movable legs with attached feet, which define an inside caliper. An elongated coil spring is coupled to both legs so as to be responsively elongated upon relative movement of the legs. A slidable spool forms an inspection window which subdivides the spring coil turns. The window cooperates with an indicator flag to measure the adequacy of the pedal reserve of an actuated brake pedal in terms of the fractional subdivision of the spring. This tool does not restrict or limit full travel of the brake pedal between its unactuated and actuated positions.

Yet another example describes adjustable simulator apparatus for testing linearly translatable vehicle components (e.g., transmissions, brakes) without connecting them to every cooperating component as they would be in the vehicle. The adjustable simulator apparatus includes a housing having a bore along a generally longitudinal axis, and first and second retainers disposed in the housing and spaced apart from one another. At least one of the retainers is adjustable and a compressible member is disposed between the retainers. The apparatus also includes a piston translatable within the bore and a mechanical stop disposed at least partially within the bore of the housing and extending through the second end of the compressible member. The simulator is complex and invasive, requiring interruption of the hydraulic portion of the host vehicle system under test.

### SUMMARY

The present disclosure provides a tool which consistently limits the travel of a host test vehicle service brake pedal to a set height with the use of a tool. The tool is configured for temporary mounting to the service brake pedal which is manually actuated for taking test data. The tool includes an adjustable arm which can be locked within a range of set positions to establish an end-of-travel stop for the test vehicle brake pedal at any desired position within its stroke. This provides for more repeatable data collection.

According to one embodiment of the disclosure, a vehicle pedal stroke limiting tool is adapted for application within a host test vehicle that includes one or more pedal assemblies disposed between a designated vehicle operator position and a forward vehicle cabin bulkhead, whereby a vehicle operator can manually (e.g., by foot) actuate a pedal assembly between a released position and an engaged (e.g., full stroke) position. The pedal stroke limiting tool includes a base member which is adapted for temporary mounting to a pedal assembly for displacement therewith, and a stop arm carried with the base member which is selectively adjustable to extend form the base member toward the cabin bulkhead for limiting displacement of the pedal assembly toward the engaged position. This arrangement enables an operator to temporarily establish a hard stop between the pedal released position and the engaged position for testing purposes.

According to another embodiment of the disclosure, a vehicle pedal stroke limiting tool is adapted for application within a host vehicle including a brake pedal assembly disposed intermediate a vehicle operator position and a vehicle cabin bulkhead, said brake pedal assembly manually operable between a released position and an engaged position, said pedal stroke limiting tool comprising a base member adapted for mounting with said brake pedal assembly for travel therewith, said base member comprising a substantially horizontally disposed base portion adapted for mounting, in application, to a foot pad of a host vehicle, and a flange portion extending downwardly adjacent the vehicle foot pad. In addition, an elongated stop arm carried with said base member and selectively adjustable to extend toward said cabin bulkhead to limit displacement of said pedal assembly toward said engaged position, said stop arm comprising an elongated slot adjacent one end thereof and an abutment end distal said elongated slot. Lastly, a fastener operative to enable relative rotational and axial repositioning of said stop arm with respect to said base member and to selectively affix said stop arm to said base member at any of a range of relative positions, said fastener comprising a threaded member extending through said elongated slot and a through bore formed in said base member flange portion.

These and other features and advantages of the disclosure will become apparent upon reading the following specification, which, along with the drawings, describes preferred and alternative embodiments of the disclosure in detail.

### BRIEF DESCRIPTION OF THE DRAWINGS

The present disclosure will now be described, by way of example, with reference to the accompanying drawings, in which:

FIG. 1 is a schematic of a pedal operatively arranged within a motor vehicle for displacement by an operator's foot between a released position (in phantom) and a fully depressed position (in phantom), wherein a stroke limiting tool is removably affixed to the pedal structure to establish an intermediate stop position for test purposes;

FIG. 2 is a front plan view of a first embodiment of a stroke limiting tool similar to that illustrated in the device of FIG. 1;

FIG. 3 is a side plan view of the stroke limiting tool of FIG. 2;

FIG. 4 is a top view of the stroke limiting tool of FIG. 2;

FIG. 5 is a front view of the stroke limiting tool of FIG. 2 mounted to the front face of a service brake pedal with temporary fasteners (e.g., zip ties);

FIG. 6 is a front plan view of a second embodiment of a stroke limiting tool, similar to that of FIG. 2, mounted to the front face of a brake pedal with temporary fasteners (e.g., zip ties), which also position and retain a puck type force transducer;

FIG. 7 graphically depicts example test data (e.g., displacement and force) representing repeated manual displacement of a service brake pedal toward a 50 mm travel target without the use of the stroke limiting tool; and

FIG. 8 graphically depicts example test data (e.g., displacement and force) representing repeated manual displacement of a service brake pedal toward a 50 mm travel target with the use of the stroke limiting tool.

Although the drawings represent various embodiments, the drawings are not necessarily to scale and certain features may be exaggerated in order to illustrate and explain the present disclosure. The exemplification set forth herein illustrates an embodiment of the present disclosure, in one form, and such exemplifications are not to be construed as limiting the scope of the present disclosure in any manner.

### DETAILED DESCRIPTION

The stroke limiting tool described here can consistently limit the travel of a service brake pedal to a pre-determined displacement. Being able to do so provides more efficient, consistent, and repeatable data collection for certain brake tests. In a broader sense, the present disclosure can also be employed for testing of any vehicle system using a foot operated pedal such as clutch, throttle, and the like. For the purposes of the present specification, the stroke limiting tool will be described in the context of passenger vehicle service brake applications.

Currently, certain brake vacuum tests are performed using an evaluator's foot to manually hold the service brake pedal in a set position subjectively established by the evaluator, resulting in inconsistent data collection.

The stroke limiting tool described here is bracket mounted to the service brake pedal and includes an adjustable elongated arm which can be locked within in a range of desired orientations and selectively shortened or lengthened to achieve any set position, stopping the brake pedal at any desired position within its range of motion. This is useful for certain brake “vacuum recovery tests”. The stroke limiting tool also has mounting features for supporting and positioning stroke and force transducers for test data collection.

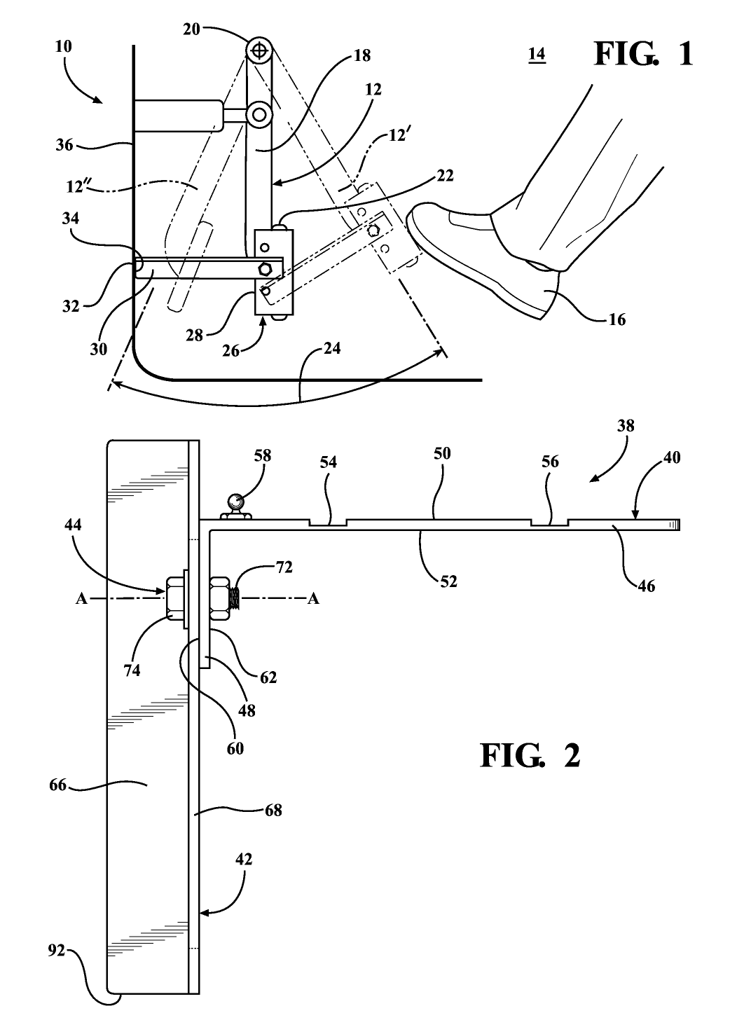

Referring to FIG. 1, a test vehicle 10 has a pedal assembly 12 pivotally mounted within the operator's compartment 14 for actuation by an operator's foot 16. In one intended application, the pedal assembly 12 is operatively arranged to selectively actuate a vehicle service brake system (not illustrated). The pedal assembly 12 includes a lever or armature 18 mounted for limited rotation about a pivot point 20 between a released position (illustrated in phantom as 12′) and a fully engaged position (illustrated in phantom as 12″). An end of the armature 18 opposite the pivot point 20 supports a foot pad or tread 22, which, in application, is pressed by the operator's foot 16 from the released position 12′ towards the engaged position 12″ to effect operation of the test vehicle 10 brake system. Travel of the pedal assembly 12 between the released position 12′ and the fully engaged position 12″ is illustrated by arcuate arrow 24.

A stroke limiting tool 26 can be carried for displacement with the pedal assembly 12. The stroke limiting tool 26 includes a base member 28 removably mounted to the pedal assembly 12, preferably to the foot pad 22, and an elongated arm 30 depending from said base member 28 as a cantilever directed generally away from the operator. A leading or abutment end 32 of the elongated arm 30 distal the base member 28 forms a stop, limiting further displacement of the pedal assembly 12 toward its nominal fully engaged position 12″ when it contacts an adjacent inner abutment surface 34 typically formed by the test vehicle cabin bulkhead 36.

Thus, with the stroke limiting tool 26 installed, a new end limit of travel of the pedal assembly 12 is temporarily established for test purposes. Each successive actuation of the pedal assembly 12 by the operator will result in the pedal assembly 12 assuming precisely the same end limit of travel intermediate the released position 12′ and the nominal fully engaged position 12″ (i.e., achievable only with the stroke limiting tool 26 removed from the test vehicle 10).

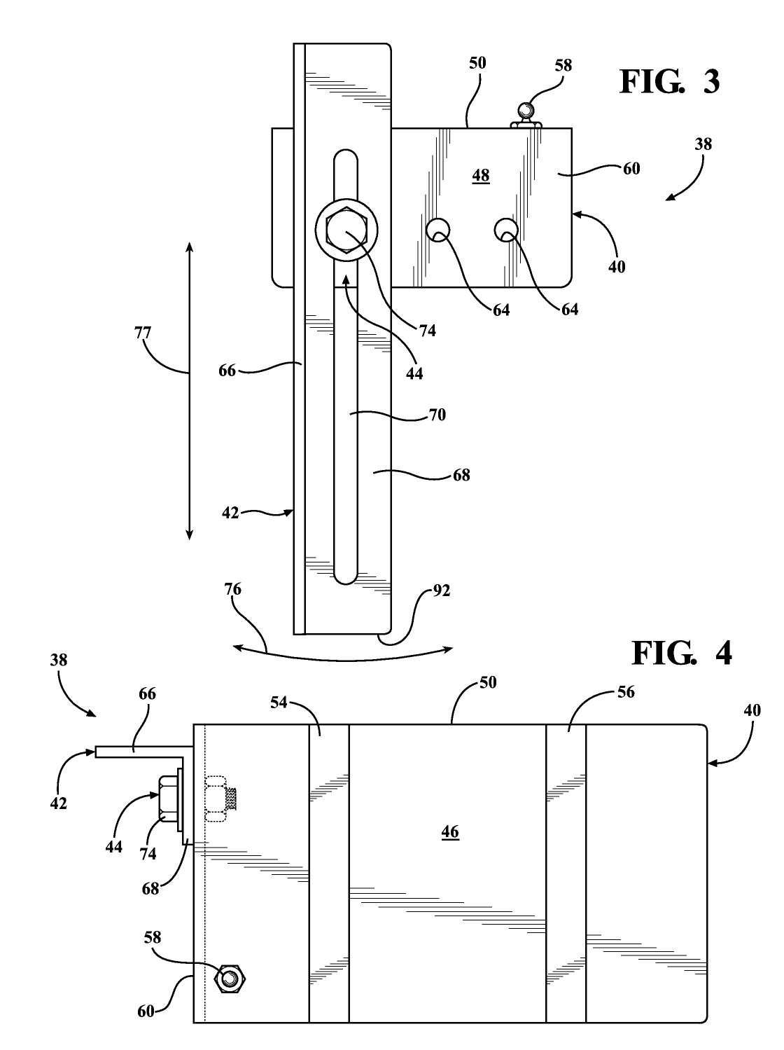

Referring to FIGS. 2-4, the detailed structure of a stroke limiting tool 38 is illustrated. The stroke limiting tool 38 comprises a base plate 40 adjustably joined to an elongated stop arm 42 by a fastener such as a bolt 44 (e.g., threaded member). As best illustrated in FIG. 2, the base plate 40 is generally “L” shaped, having a generally rectangular, horizontally elongated base portion 46 integrally joined along one edge thereof with a vertically downwardly extending flange portion 48. The base portion 46 is substantially planer and defines an upper surface 50 and a lower surface 52. Left and right elongated recesses 54 and 56, respectively, are formed in the upper surface 50 of the base portion 46 in a parallel, spaced-apart orientation to define mounting features. A sensor attachment feature, such as a ball stud 58 is affixed to the base portion 46 and extends above the upper surface 50. The flange portion 48 has left and right facing wall surfaces, 60 and 62, respectively. A plurality of spaced apart threaded through bores 64 (e.g., three are illustrated) extend through the flange portion 48 along axes generally parallel to the surfaces 50, 52 defined by the base portion 46 (e.g., axis A-A in FIG. 3). Alternatively, smooth through bores 64 can be employed using a nut on right wall surface 62.

The stop arm 42 can be an elongated, vertically extending “L” beam consisting of a laterally extending flange portion 66 and a longitudinally extending flange portion 68. The longitudinally extending flange portion 68 has an elongated slot 70 formed therein. The slot 70 is configured such that it has a major dimension extending along a substantial portion of the axial length of the flange portion 68 and a nominal width dimensioned to slightly exceed the nominal diameter of a shank portion 72 of the bolt 44. Further, the nominal diameter of a head portion 74 of the bolt 44 substantially exceeds the nominal width of the elongated slot 70.

When assembled, the longitudinally extending flange portion 68 is positioned in an abutting relationship with the left wall surface 60 of the flange portion 48 of the base plate 40. The bolt shank 72 extends through the elongated slot 70 and threadably engages one of the bores 64, or alternatively, a mating nut, whereby the longitudinally extending flange portion 68 (as well as the stop arm 42) is captured in its illustrated orientation between the bolt head 74 and the left wall surface 60 of the flange portion 48 of the base plate 40 whenever the bolt 44 is suitably tightened. When the bolt 44 is tightened, the stroke limiting tool 38 functions as a single integrated or unitary structure. For adjustment purposes, the bolt 44 is temporarily loosened whereby the stop arm 42 is rotationally repositionable with respect to the base plate 40 about an axis defined by the bolt 44/bore 64 as indicated by arrow 76. Furthermore, when the bolt 44 is temporarily loosened, the stop arm 42 is axially repositionable with respect to the base plate 40 along the axis of elongation of the stop arm 42 as indicated by arrow 77.

The base plate 40, elongated stop arm 42, and bolt 44 are preferably each formed of mild steel or other suitable material capable of withstanding forces applied by an operator's foot 16 under prolonged testing conditions without bending, fracture, distortion, fatigue or the like.

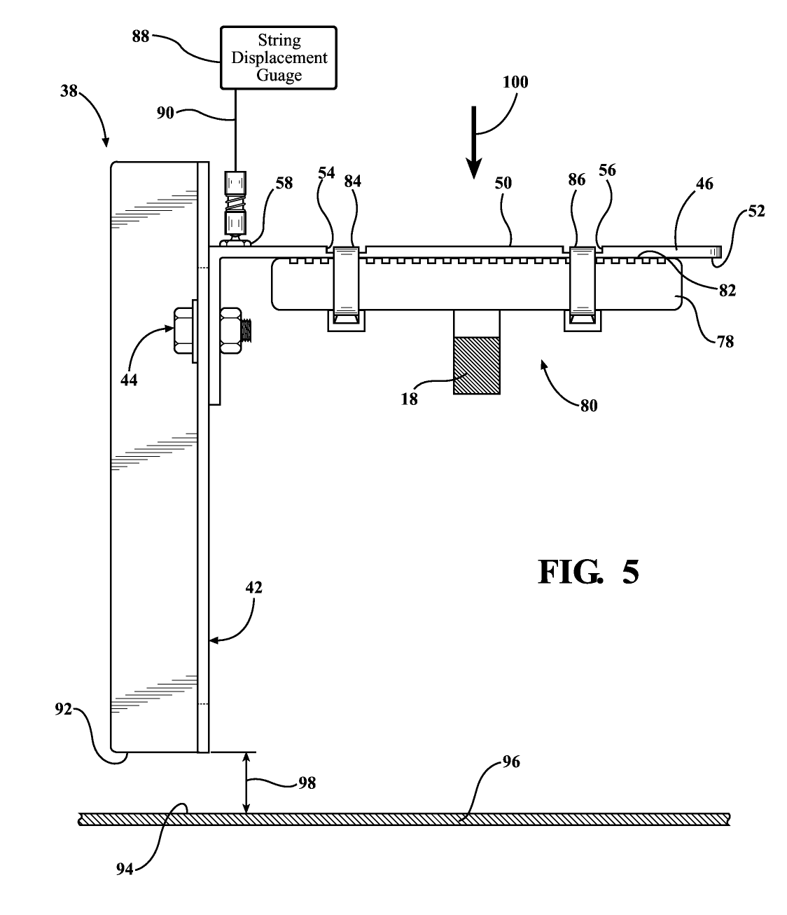

Referring to FIG. 5, the stroke limiting tool 38 of FIGS. 2-4 is affixed to a foot pad 78 of a pedal assembly 80 in an orientation similar to that illustrated in FIG. 1 for purposes of testing and data acquisition. The foot pad 78 is typically formed of resilient material such as rubber. When so mounted, the lower surface 52 of the base portion 46 of the base plate 40 abuts an upper surface 82 of the foot pad 78. The stroke limiting tool 38 is retained in its illustrated orientation by retainers, such as left and right zip ties 84 and 86, respectively, which girdle the assembly and are cinched tight to slightly compress the foot pad 78 to retain the zip ties 84 and 86 in tension. The zip ties 84 and 86 are routed within recesses 54 and 56 to prevent lateral relative displacement between the foot pad 78 and the stroke limiting tool 38.

The stroke limiting tool 38 can be installed in a host test vehicle 10 as illustrated in FIG. 5 with the pedal assembly 80 in its release position 12′. Thereafter, the bolt 44 can be loosened, and the stop arm 42 axially and rotationally positioned as described herein above, and the bolt 44 can be retightened. Typically, an abutment end 92 of the stop arm 42 is oriented in a spaced relation from the adjacent surface 94 of the vehicle cabin bulkhead 96 by a predetermined dimension designated by arrow 98. Lastly, a string displacement gauge 88 (or other suitable test instrumentation) is mounted within the host test vehicle 10 and its input string 90 attached to the ball stud 58.

During testing, the operator preferably sits in the vehicle driver's position and repeatedly presses his foot 16 against the upper surface 50 of the base portion 46 of the base plate 40 as indicated by arrow 100. This arrangement best replicates the forces typically applied to the vehicle brake pedal during actual driving conditions. It is contemplated that a device for effecting automated cyclic brake actuation could also be employed. During each cycle, the pedal assembly 80 is depressed from its release position 12′ toward its fully engaged position 12″. However, at an intermediate point mid-stroke, the abutting end 92 of the stop arm 42 contacts the adjacent surface 94 of the bulkhead 96 and ceases its stroke travel. The operator then removes his foot 16 to release the pedal assembly 80 for return to its release position 12′. This process can be continued to acquire performance and trend data for future evaluation.

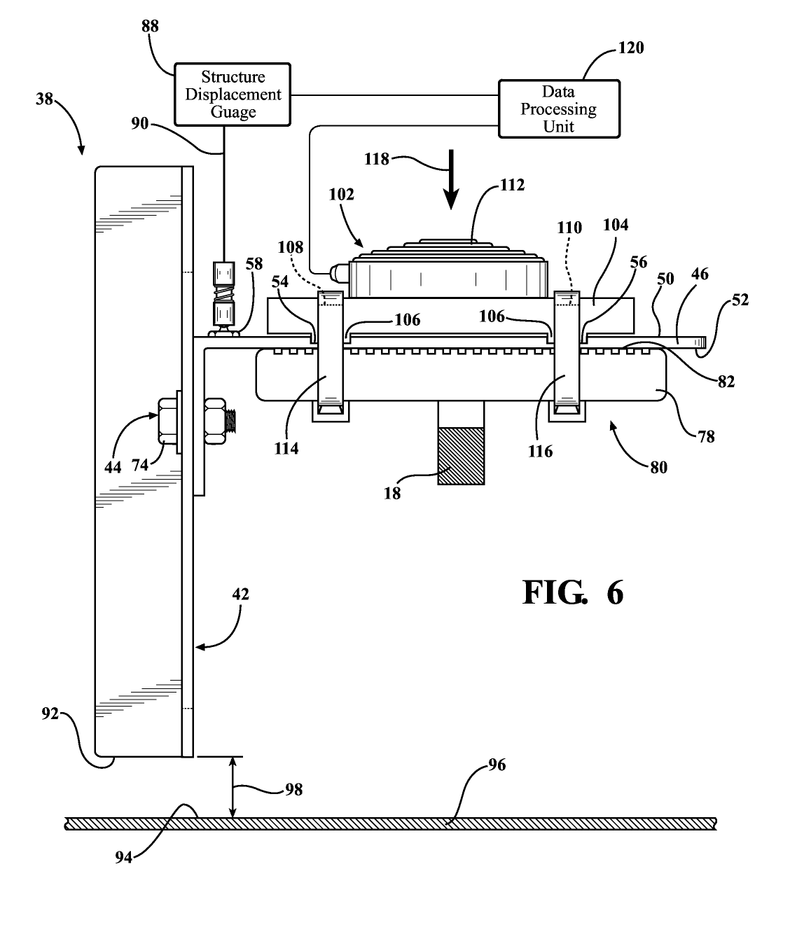

Referring to FIG. 6, the stroke limiting tool 38 of FIGS. 2-4 is affixed to a foot pad 78 of a pedal assembly 80 in an orientation similar to that illustrated in FIG. 1 for purposes of testing and data acquisition. When so mounted, the lower surface 52 of the base portion 46 of the base plate 40 abuts an upper surface 82 of the foot pad 78. A force transducer 102 is applied to the upper surface 50 of the base portion 46 of the stroke limiter tool 38. The force transducer 102 includes a base member 104 forming downwardly extending engagement features, such as foot extensions 106 which, when applied to the upper surface 50 of the base portion 46, register with and lockingly engage within recesses 54 and 56 to prevent relative lateral motion therebetween. The force transducer base member 104 includes spaced apart left and right recesses 108 and 110 and a puck-type pressure transducer 112 centered therebetween.

The stroke limiting tool 38 and force transducer 102 are retained in their illustrated orientation by retainers, such as left and right zip ties 114 and 116, respectively, which girdle the assembly and are cinched tight to slightly compress the foot pad 78 to retain the zip ties 114 and 116 in tension. The zip ties 114 and 116 are routed within recesses 108 and 110 formed in the transducer base member 104 to prevent lateral relative displacement between the foot pad 78, stroke limiting tool 38, and force transducer 102.

During testing, the operator preferably sits in the vehicle driver's position and repeatedly presses his foot 16 against the puck-type pressure transducer 112 of the force transducer 102, as indicated by arrow 118. The string displacement gauge 88 and the force transducer 102 provide output signals to a data processing unit 120 to acquire performance and trend data for future evaluation.

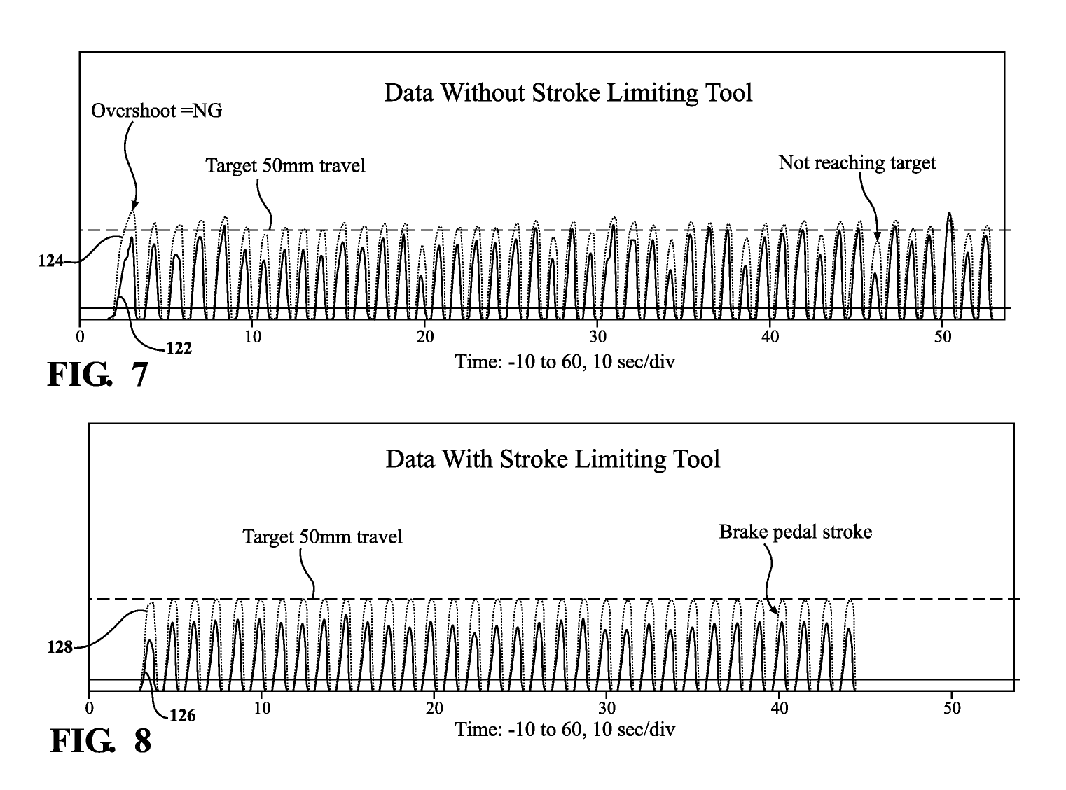

Referring to FIG. 7, example vacuum brake test without the use of the stroke limiting tool 38 is depicted by overlaying force and pedal assembly displacement response curves 122 and 124, respectively. It is to be noted that, without the stroke limiting tool 38 there are numerous occurrences of inadequate or excessive actuation force and overshoot (of a 50 mm travel target) on given cycles, resulting in inconsistent system performance data.

Referring to FIG. 8, example vacuum brake test data including the use of the stroke limiting tool 38 is depicted by overlaying force and pedal assembly displacement response curves 126 and 128, respectively. It is to be noted that, with the stroke limiting tool of the present invention, there are no occurrences of inadequate or excessive actuation force and overshoot (of a 50 mm travel target) on given cycles, resulting in extremely consistent system performance data.

It is to be understood that the invention has been described with reference to specific embodiments and variations to provide the features and advantages previously described and that the embodiments are susceptible of modification as will be apparent to those skilled in the art. Furthermore, it is contemplated that many alternative, common inexpensive materials can be employed to construct the basic constituent components. Accordingly, the forgoing is not to be construed in a limiting sense.

The tool has been described in an illustrative manner, and it is to be understood that the terminology, which has been used is intended to be in the nature of words of description rather than of limitation.

Obviously, many modifications and variations of the tool are possible in light of the above teachings. For example, it is contemplated that a brake pedal stroke limiter tool 38 could be supported by a brake system armature 18, or elsewhere in the test vehicle brake pedal linkage assembly 12. Furthermore, elongated slots 70 can be formed in both flange portions 48 and 68 of the base plate 40 and the stop arm 42, respectively, and a bolt/nut combination 44 employed to engage the base plate 40 and stop arm 42 in any desired relative positioning. It is, therefore, to be understood that within the scope of the appended claims, wherein reference numerals are merely for illustrative purposes and convenience and are not in any way limiting, the tool, which is defined by the following claims as interpreted according to the principles of patent law, including the Doctrine of Equivalents, may be practiced otherwise than is specifically described.

1. A vehicle pedal stroke limiting tool adapted for application within a host vehicle including a pedal assembly disposed intermediate a vehicle operator position and a vehicle cabin bulkhead, said pedal assembly manually operable between a released position and an engaged position, said pedal stroke limiting tool comprising:
a base member adapted for mounting with said pedal assembly for travel therewith; and
a stop arm carried with said base member and selectively adjustable to extend toward said cabin bulkhead for limiting displacement of said pedal assembly toward said engaged position.

2. The pedal stroke limiting tool of claim 1, wherein said pedal stroke limiting tool comprises a vehicle brake pedal stroke limiter.

3. The pedal stroke limiting tool of claim 1, wherein said stop arm is elongated, defining an attachment feature and an abutment end distal said attachment feature.

4. The pedal stroke limiting tool of claim 1, further comprising a fastener operable to enable relative repositioning of said stop arm with respect to said base member, and to selectively affix said stop arm to said base member at any of a range of relative positions.

5. The pedal stroke limiting tool of claim 4, wherein said fastener is operable to enable relative rotational repositioning of said stop arm with respect to said base member about an axis extending substantially parallel to a plane defined by said base member.

6. The pedal stroke limiting tool of claim 4, wherein said fastener is operable to enable relative axial repositioning of said stop arm with respect to said base member.

7. The pedal stroke limiting tool of claim 4, wherein said fastener comprises a threaded member extending through an elongated slot formed in either said stop arm or said base member, and a through hole formed in the other of said stop arm or said base member.

8. The pedal stroke limiting tool of claim 4, wherein said fastener comprises a threaded member extending through an elongated slot formed in either said stop arm or said base member, and one of a plurality of longitudinally spaced through holes formed in the other of said stop arm or said base member.

9. The pedal stroke limiting tool of claim 4, wherein said fastener means comprises a threaded bolt.

10. The pedal stroke limiting tool of claim 1, wherein said base member comprises mounting features operative for releasably engaging said pedal assembly.

11. The pedal stroke limiting tool of claim 10, wherein said base member mounting features comprise at least one elongated recess formed therein.

12. The pedal stroke limiting tool of claim 11, further comprising at least one cinching device configured for disposition within said elongated recess for compressively loading said base member against a resilient portion of said pedal assembly.

13. The pedal stroke limiting tool of claim 1, further comprising at least one sensor attachment device.

14. The pedal stroke limiting tool of claim 13, wherein said at least one sensor attachment device comprises an input interface for a pedal assembly displacement transducer.

15. The pedal stroke limiting tool of claim 13, wherein said at least one sensor attachment device comprises an input interface for a pedal assembly operator applied force transducer.

16. The pedal stroke limiting tool of claim 1, wherein said base member is configured, in application, for mounting to an upper surface of a foot pad portion of a pedal assembly, whereby an operator's input force to said pedal assembly is applied directly to an upper surface of said base member.

17. The pedal stroke limiting tool of claim 1, wherein said base member is configured, in application, for mounting to an upper surface of a foot pad portion of a pedal assembly, and an applied force transducer is configured for mounting to an upper surface of the base member, whereby an operator's input force to said pedal assembly is applied directly to an upper surface of said applied force transducer.

18. A vehicle pedal stroke limiting tool adapted for application within a host vehicle including a brake pedal assembly disposed intermediate a vehicle operator position and a vehicle cabin bulkhead, said brake pedal assembly manually operable between a released position and an engaged position, said pedal stroke limiting tool comprising:
a base member adapted for mounting with said brake pedal assembly for travel therewith, said base member comprising a substantially horizontally disposed base portion adapted for mounting, in application, to a foot pad of a host vehicle, and a flange portion extending downwardly adjacent said vehicle foot pad;
an elongated stop arm carried with said base member and selectively adjustable to extend toward said cabin bulkhead to limit displacement of said pedal assembly toward said engaged position, said stop arm comprising an elongated slot adjacent one end thereof and an abutment end distal said elongated slot; and
a fastener operative to enable relative rotational and axial repositioning of said stop arm with respect to said base member and to selectively affix said stop arm to said base member at any of a range of relative positions, said fastener comprising a threaded member extending through said elongated slot and a through formed in said base member flange portion.

19. The pedal stroke limiting tool of claim 18, further comprising a first sensor attachment device carried on said base portion for affixing a pedal displacement transducer, and a second sensor attachment device carried on said base portion for affixing an operator applied force transducer.

20. A vehicle pedal stroke limiting tool comprising:
a base member adapted for mounting with a host vehicle pedal assembly for travel therewith between a released position and an engaged position;
an elongated stop arm carried by said base member and extending toward a host vehicle cabin forward bulkhead; and
a fastener releasably interconnecting said stop arm to said base member and operable to enable relative axial and rotational repositioning of said stop arm with respect to said base member to establish a stop for said pedal assembly at a location intermediate said released position and said engaged position wherein said elongated stop arm abuts said forward bulkhead.
